(19) United States
(12) Patent Application Publication
(10) Pub. No.: US 2018/0017800 A1
(43) Pub. Date: Jan. 18, 2018

(54) VIRTUAL IMAGE DISPLAY APPARATUS

(71) Applicant: KYOCERA Corporation, Kyoto (JP)

(72) Inventor: Seiji HORII, Yokohama-shi (JP)

(73) Assignee: KYOCERA Corporation, Kyoto (JP)

(21) Appl. No.: 15/647,042

(22) Filed: Jul. 11, 2017

(30) Foreign Application Priority Data
Jul. 15, 2016 (JP) 2016-140685

(51) Int. Cl. G02B 27/14; G02B 27/01

(52) U.S. Cl. CPC G02B 27/14; G02B 27/0172

(57) ABSTRACT

A virtual image display apparatus that improves a visibility of a displayed virtual image is provided. The virtual image display apparatus includes a display and an optical member. The optical member reflects a light of an image displayed by a display to eyes of a subject and displays a virtual image of the image in the field of vision of the subject. The optical member includes a plurality of mirrors, each having an angle with respect to a reference plane of the optical member different from each other.

### CROSS REFERENCE TO RELATED APPLICATION

This application claims priority to and the benefit of Japanese Patent Application No. 2016-140685 filed on Jul. 15, 2016, the entire contents of which are incorporated herein by reference.

### TECHNICAL FIELD

The present disclosure relates to a virtual image display apparatus that displays a virtual image in a subject's field of vision.

### BACKGROUND

A virtual image display apparatus that displays a virtual image of a raw image displayed by a display in a subject's field of vision has been known.

### SUMMARY

The virtual image display apparatus according to one embodiment of the present disclosure includes a display and an optical member. The optical member reflects a light of an image displayed by a display toward eyes of a subject and displays a virtual image of the image in the subject's field of vision. The optical member includes a plurality of mirrors, each having a different angle with respect to a reference plane of the optical member.

In the virtual image display apparatus according to one embodiment of the present disclosure, the visibility of a displayed virtual image is improved.

### BRIEF DESCRIPTION OF THE DRAWINGS

In the accompanying drawings:

FIG. 1 is a functional block diagram illustrating a schematic configuration of a virtual image display apparatus according to one embodiment of the present disclosure;

FIG. 2 is a schematic side view of the virtual image display apparatus mounted on a subject;

FIG. 3 is a schematic front view of a display surface;

FIG. 4 is a schematic diagram of an optical member viewed vertically to a reference plane;

FIG. 5 is an enlarged view of principal components, such as a display and an optical member, illustrated in FIG. 2;

FIG. 6 is a diagram illustrating an example of raw images displayed by the display;

FIG. 7 is a diagram illustrating an example of a virtual image displayed by the optical member;

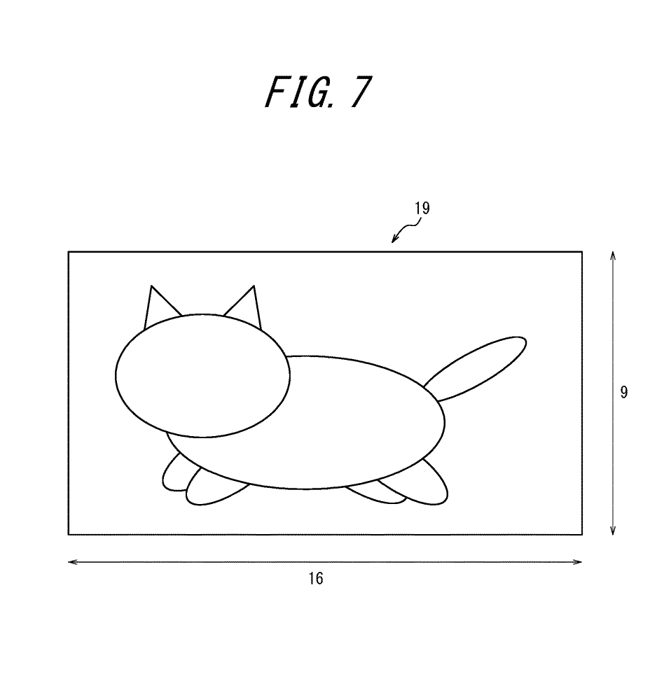

FIG. 8 is a diagram illustrating an example of raw images displayed by the display as a comparative example; and

FIG. 9 is a schematic side view of a virtual image display apparatus mounted on the subject according to a variation of the embodiment.

### DETAILED DESCRIPTION

For example, a spectacle type head mount display that displays a raw image displayed on a screen as a virtual image in a subject's field of vision via a refractive lens and a flat half mirror has been known.

The virtual image display apparatus known in the art has had room for improvement in visibility of virtual images. It is an object of the present disclosure to provide a virtual image display apparatus that improves the visibility of displayed virtual images.

One embodiment will be described below with reference to drawings.

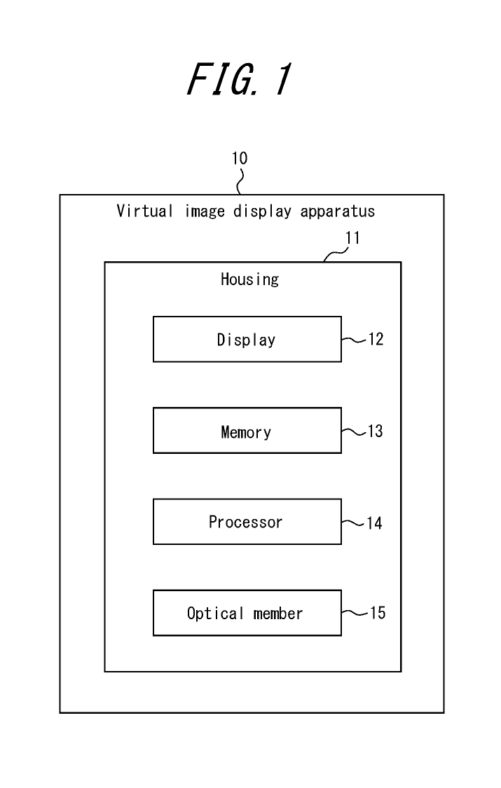

A virtual image display apparatus 10 according to one embodiment will be described with reference to FIG. 1. The virtual image display apparatus 10 according to one embodiment includes a housing 11, a display 12, a memory 13, a processor 14 and an optical member 15.

The housing 11 houses and holds the display 12, the memory 13, the processor 14 and the optical member 15. The housing 11 may be made of material. such as resin and metal. The housing 11 is formed to define a position of the virtual image display apparatus 10 with respect to the subject when the subject wears the virtual image display apparatus 10. For example, the housing 11 may be formed into a pair of spectacles or a pair of goggles. In one embodiment, the virtual image display apparatus 10 is mounted on a subject's head, for example, to allow the optical member 15 held by the housing 11 to locate in the subject's field of vision.

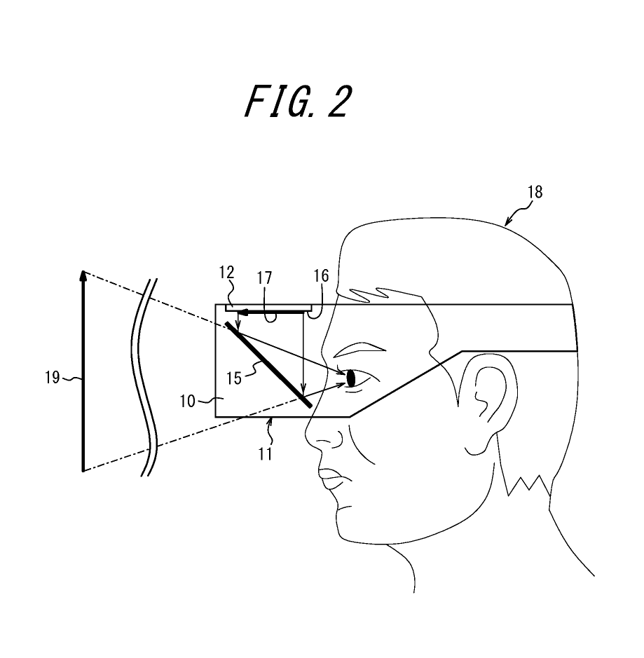

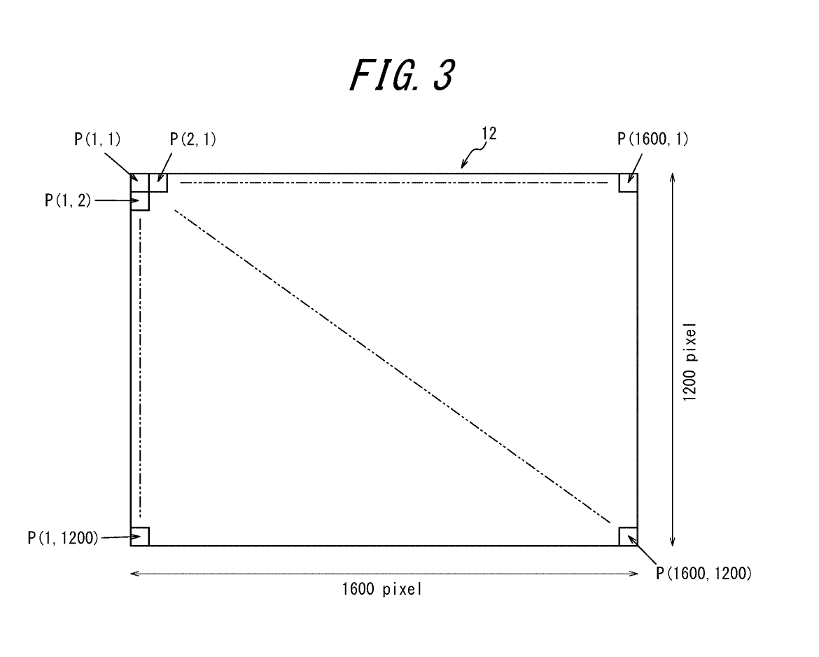

The display 12 includes an optional display apparatus, such as a liquid crystal display (LCD) and an organic light emitting display (OELD). A plurality of pixels P are disposed on a display surface of the display 12 in an array. For example, as illustrated in FIG. 2, the display 12 is housed and held in the housing 11 so that the display surface 16 faces inward of the housing 11. Any pixel size may be defined for the display 12. Hereinafter the pixel size of the display 12 is assumed to be 1600×1200 as illustrated in FIG. 3. Each pixel P disposed on the display 12 may be referred to also as pixels P (1,1), . . . , and pixels P (1600, 1200).

The display 12 can display various images. For example, the display 12 displays a predetermined raw image under control of the processor 14 as described later. The raw image is an image displayed as a virtual image in the subject's field of vision by the virtual image display apparatus 10. In one embodiment, a raw image includes a first image for the left eye and a second image for the right eye. In the other embodiment, the raw image may be a single image. In one embodiment, an image may include a static image or a dynamic image. A configuration by which a virtual image of a raw image is displayed and details of a raw image will be described later.

The memory 13 illustrated in FIG. 1 includes a primary storage device or a secondary storage device, for example. The memory 13 may include a semiconductor memory, a magnetic memory or an optical memory. In one embodiment, the memory 13 stores various information and programs required for operating the virtual image display apparatus 10. For example, the memory 13 stores raw images.

The processor 14 includes one or more general purpose processors that read a specific program to implement a specific function or one or more dedicated processors for a specific processing. The processor 14 controls the entire operation of the virtual image display apparatus 10. For example, the processor 14 allows the display 12 to display raw images stored in the memory 13.

The optical member 15 is housed and held in the housing 11 as illustrated in FIG. 2, for example, so that it reflects a light of the raw image 17 displayed by the display 12 toward eyes of the subject 18 who wears the virtual image display apparatus 10. The light reflected by the optical member 15 allows the virtual image 19 of the raw image 17 to be displayed in the field of vision of the subject 18.

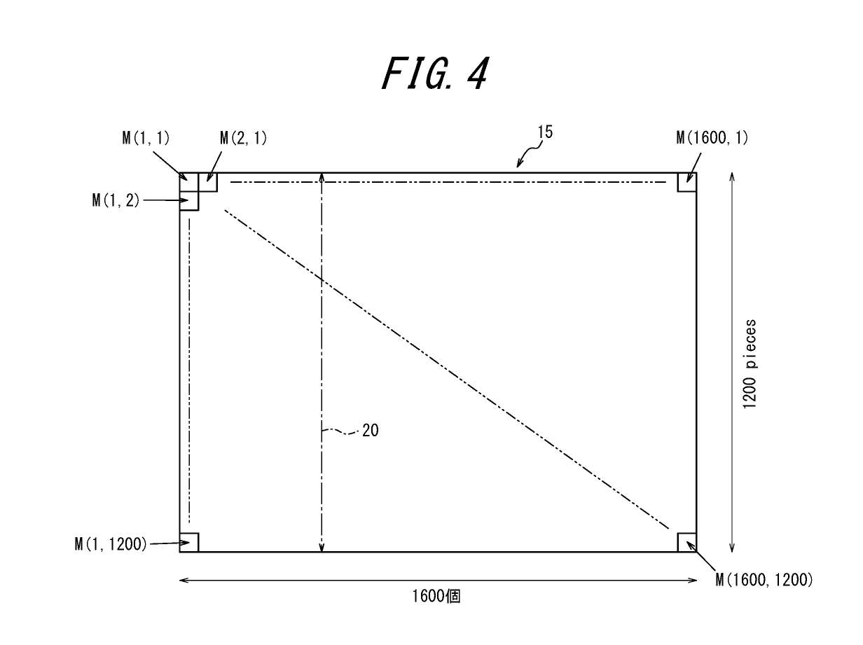

The optical member 15 includes a plurality of micro mirrors M disposed in an array as illustrated in FIG. 4, for example. Hereinafter the surface of the optical member 15 on which a plurality of mirrors M are disposed is referred to also as a reference plane. The reference plane may be a plane actually included in the optical member 15 or may be a virtual plane conceived of with respect to the optical member 15. In one embodiment, the optical member 15 is a substantially flat plane. The reference plane may be a plane extending along the substantially flat plane, for example. In FIG. 4, although the optical member 15 is formed into a rectangular viewed vertically to the reference plane, it may be formed into any shapes, such as a trapezoidal or an elliptical shape. In the other embodiment, the optical member 15 may be formed into a curved shape, for example. In this case, the reference plane may be a curve extending along the curved shape. The curve may be spherical or non-spherical, for example.

The mirrors M are provided each corresponding to respective first areas on the display surface 16 of the display 12. Each first area includes one or more pixels P of a plurality of pixels P. In one embodiment, each first area 1 includes one pixel P. Therefore, in one embodiment, each mirror M is provided corresponding to each first area, that is, each pixel P. In this case, if the pixel size of the display 12 is 1600×1200, the number of mirrors M included in the optical member 15 is 1600×1200 pieces. Hereinafter each mirror M is referred to also as mirror M (1, 1), . . . , and mirror M (1600, 1200). The mirror M (1, 1), . . . , and the mirror M (1600, 1200) correspond to the pixel P (1, 1), . . . , and the pixel P (1600, 1200), respectively.

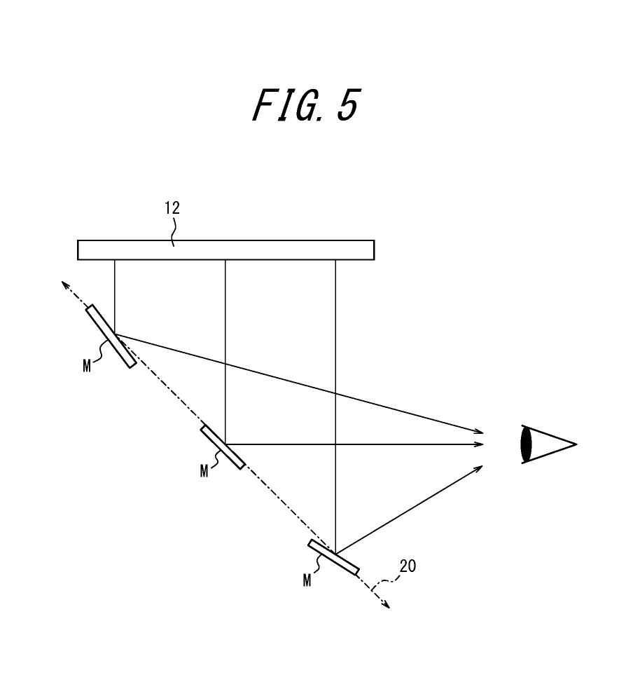

The angle of each mirror M's surface is adjusted with respect to the reference plane of the optical member 15 so that each mirror reflects the light emitted from corresponding respective first areas on the display 12 toward eyes of the subject 18. Thus, for example, the angle of each mirror M's surface with respect to the reference plane of the optical member 15 varies along any one or more directions parallel to the reference plane of the optical member 15. For example, as illustrated in FIG. 5, the angle of each mirror M's surface with respect to the reference plane is sequentially increased or decreased along the longitudinal direction 20 which is parallel to the reference plane of the optical member 15 as illustrated in FIG. 4, for example. The change in the angle of each mirror M's surface along the direction parallel to the reference plane of the optical member 15 is not limited to the above described configuration. For example, the angle of each mirror M's surface with respect to the reference plane may be sequentially increased or decreased along at least one of the first direction and the second direction which is parallel to the reference plane of the optical member 15, for example.

In one embodiment, some of the mirrors M reflect the light of the first image for the left eye included in the raw image 17 toward the left eye of the subject 18 and the rest of the mirrors M reflect the light of the second image for the right eye included in the raw image 17 toward the right eye of the subject 18. The first image and the second image may be the same image. Two images respectively formed on the left and right retinas of the subject 18 by lights from the first image and the second image are fused by and recognized as one image by the subject 18. Alternatively, the first image and the second image may be a set of parallax images. In this case, the virtual image display apparatus 10 can display the virtual image 19 in three dimensions (3D) by utilizing disparity, for example.

As described above, the display mode of the virtual image 19 is adjusted by adjusting the angle of each mirror M's surface with respect to the reference plane of the optical member 15. The display mode of the virtual image 19 may include, for example, the size, the shape, and the aspect ratio of the virtual image 19 displayed by the optical member 15, the position in the depth direction where the virtual image 19 is displayed, and the display position of the virtual image 19 in the field of vision of the subject 18 and the like. In one embodiment, the angle of each mirror M is adjusted so that it will be a desired angle in manufacture of the optical member 15, for example. Specifically, as described later, the angle of each mirror M is adjusted so that the aspect ratio of the raw image 17 displayed by the display 12 is different from that of the virtual image 19 displayed by the optical member 15. The aspect ratio of the raw image 17 and that of the virtual image 19 will be described later.

In the other embodiment, the angle of each mirror M may be dynamically adjusted by a drive provided corresponding to each mirror M. A micro electro mechanical systems (MEMS) actuator and the like may be adopted as a drive.

Each mirror M may have a reflectance of irradiation light sufficiently larger than a transmissivity thereof. According to this configuration, the virtual image display apparatus 10 serves as what is called an immersive head mount display apparatus by which the subject 18 can visually recognize only the virtual image 19 of the raw image 17 through the optical member 15.

Alternatively, each mirror M may be a beam splitter, such as a half mirror, for example. In this case, the optical member 15 reflects the light of an image displayed by the display 12 toward the eyes of the subject 18 and transmits the light coming from outside the virtual image display apparatus 10 toward the eyes of the subject 18. According to this configuration, the virtual image display apparatus 10 serves as what is called a see-through head mount display by which the subject 18 can visually recognize both the virtual image 19 and outside through the optical member 15.

(Raw Image and Virtual Image)

The raw image 17 displayed by the display 12 and the virtual image 19 displayed by the optical member 15 will be described in detail.

As a specific example, a configuration in which the virtual image display apparatus 10 displays a movie image as a virtual image 19 will be described below. In this case, as described later, an image produced by compressing an original image of the movie supplied by a movie provider is used as the raw image 17. In one embodiment, the raw image 17 may be stored in the memory 13 in or after manufacture of the virtual image display apparatus 10, for example. In the other embodiment, in place of the raw image 17, an original image may be stored in the memory 13. In this case, the processor 14 may produce the raw image 17 by compressing an original image.

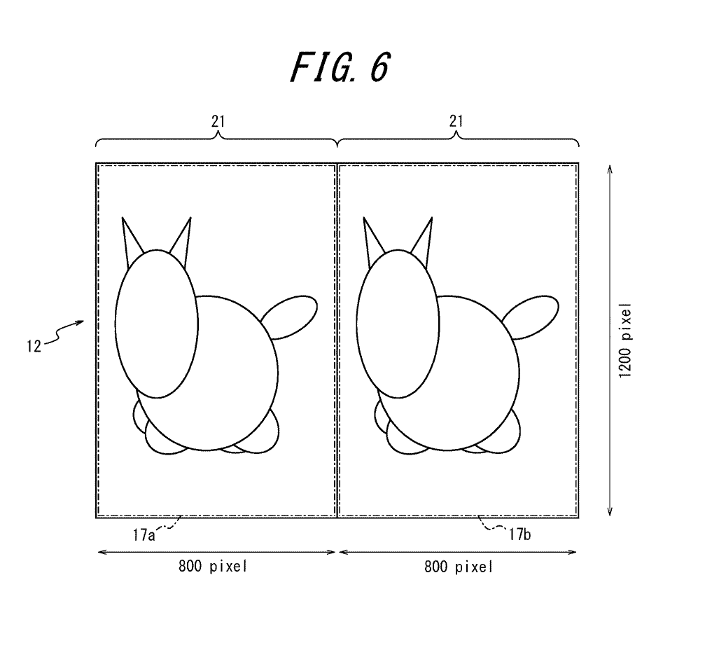

In one embodiment, as illustrated in FIG. 6, the raw image 17 includes a first image 17a for the left eye and a second image 17b for the right eye. The first image 17a and the second image 17b are respectively displayed on each second area 21 provided by dividing the display 12 into two in the horizontal direction. The pixel size of each second area 21 is 800×1200 which is provided by dividing the pixel size of the entire display 12 into two in the horizontal direction. In this case, the aspect ratio of each second area 21 is 2:3.

Meanwhile, the pixel size of the original image of the movie is larger than that of the display 12 and is assumed to be 3840×2160, for example. In this case, the aspect ratio of the original image of the movie is different from that of the display 12 and is 16:9.

The original image of the movie with a pixel size of 3840×2160 is compressed without maintaining the aspect ratio so that it will be substantially the same pixel size as that of each second area 21 of the display 12, which is 800×1200, in this case. The compressed original images are used as the first image 17a and the second image 17b, respectively. In this specific example, the aspect ratio of the original image before compression is 16:9, which is different from the aspect ratio of each second area 21 of the display 12, which is 2:3. Thus, respective compression ratios of the first image 17a and the second image 17b are different between the horizontal direction and the longitudinal direction. Specifically, the first image 17a and the second image 17b each have the compression ratio in the horizontal direction of 800 pixels/3840 pixels×100% 20.8%. Meanwhile, the first image 17a and the second image 17b each have the compression ratio in the longitudinal direction of 1200 pixels/2160 pixels×100% 55.6%. Thus, the first image 17a and the second image 17b each have a compression degree in the longitudinal direction smaller than that in the horizontal direction. Consequently, the first image 17a and the second image 17b are each compressed stronger in the horizontal direction than in the longitudinal direction, and are eventually distorted.

The optical member 15 reflects the light of the above described first image 17a and the second image 17b displayed by the display 12 to display the virtual image 19 in the field of vision of the subject 18. Each angle of the mirrors M included in the optical member 15 is adjusted to allow the aspect ratio of the displayed virtual image 19 will be substantially the same as that of the original image, 16:9. In other words, the optical member 15 reflects the light of the raw image 17 with the aspect ratio of 2:3 and displays the virtual image 19 with the aspect ratio of 16:9 in the field of vision of the subject 18. According to this configuration, the image quality of the virtual image 19 is improved as described below.

As described above, the pixel size of the original image of the movie (e. g. 3840×2160) is different from that of each second area 21 on the display 12 for displaying the first image 17a and the second image (e. g. 800×1200), respectively. Thus, the raw image 17 that is produced by compressing the original image corresponding to the pixel size of each second area 21 on the display 12 will be needed.

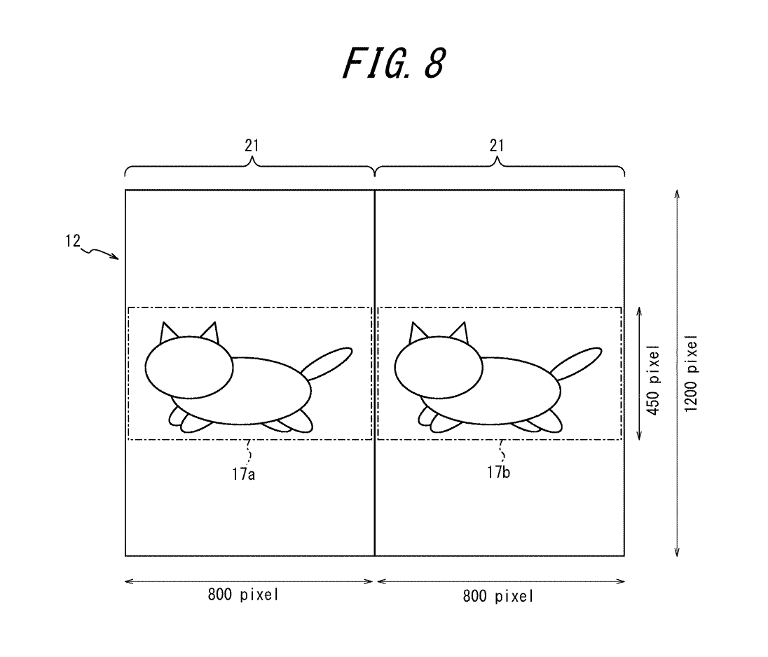

For example, in a comparative example where an original image is compressed while the aspect ratio of the original image, 16:9, is maintained, the first image 17a and the second image 17b each have the pixel size of up to 800×450 as illustrated in FIG. 8, for example. When the pixel size of the original image is 3840×2160, the first image 17a and the second image 17b each have the same compression ratio of about 20.8% in the horizontal direction and the longitudinal direction.

Meanwhile, in one embodiment, the original image is compressed without maintaining its aspect ratio. Thus, the first image 17a and the second image 17b each have the pixel size of up to 800×1200 as illustrated in FIG. 6, for example. When the pixel size of the original image is 3840×2160, the first image 17a and the second image 17b each have the compression ratio in the horizontal direction of about 20.8%, which is the same as that of the comparative example. Meanwhile, the compression ratio in the longitudinal direction is different from that of the above described comparative example and is about 55.6%. Thus, according to one embodiment, the raw image 17 having a compression degree in the longitudinal direction smaller than that of the above described comparative example can be adopted, and thus the image quality of the virtual image 19 can be improved.

As described above, in the virtual image display apparatus 10 according to one embodiment 10, the optical member 15 reflects the light of the raw image 17 displayed by the display 12 toward the eyes of the subject 18, and displays the virtual image 19 of the raw image 17. The mirrors M included in the optical member 15 respectively have angles different from each other with respect to the reference plane. The display mode of the virtual image 19 is adjusted based on each angle of the mirrors M, and thus the visibility of the virtual image 19 can be improved. The display mode of the virtual image 19 may include, for example, the size and the aspect ratio of the virtual image 19, the position in the depth direction where the virtual image 19 is displayed and the position where the virtual image 19 is displayed in the field of vision of the subject 18.

Moreover, according to one embodiment, compared to a configuration in which a member, such as a lens, for adjusting the display mode of the virtual image 19 is disposed between the display 12 and the mirror M that reflects the light from the display 12, the display mode of the virtual image 19 can be adjusted without adding a member. Thus downsizing of the entire apparatus and cost reduction can be achieved.

In one embodiment, each angle of the mirrors M included in the optical member 15 may be adjusted so that the aspect ratio of an image displayed by the display 12 is different from that of the virtual image 19 displayed by the optical member 15. According to this configuration, compared to the above described comparative example, the raw image 17 with a smaller compression degree in the horizontal or the longitudinal direction can be adopted, and thus the image quality of the virtual image 19 can be improved.

Although the present disclosure has been described with reference to the accompanying drawings and embodiments, it is to be noted that various changes and modifications will be apparent to those skilled in the art based on the present disclosure. Therefore, such changes and modifications are to be understood as included within the scope of the present disclosure. For example, the functions and the like included in the members, steps, and the like may be reordered in any logically consistent way. Furthermore, members, steps, and the like may be combined into one or divided.

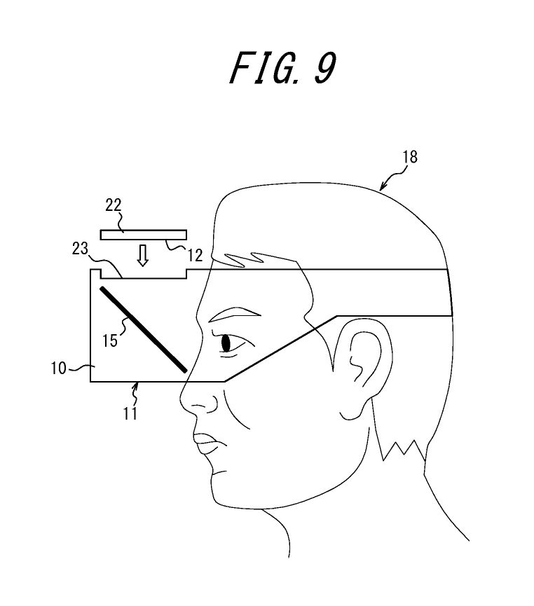

For example, the external apparatus 22, such as a mobile phone or a smartphone, may include the display 12, the memory 13 and the processor 14 according to the above described embodiment. In this case, the virtual image display apparatus 10 includes an attaching portion 23 to which the external apparatus 22 can be attached. For example, as illustrated in FIG. 9, the attaching portion 23 holds the external apparatus 22 so that the light from the display 12 of the external apparatus 22 is irradiated to the optical member 15.

1. A virtual image display apparatus, comprising:
a display; and
an optical member configured to reflect a light of an image displayed by the display toward eyes of a subject and to display a virtual image of the image in the subject's field of vision, wherein
the optical member includes a plurality of mirrors, each having an angle with respect to a reference plane of the optical member different from each other.

2. A virtual image display apparatus, comprising:
an attaching portion to which an external display can be attached; and
an optical member configured to reflect a light of an image displayed by the external display toward eyes of a subject and to display a virtual image of the image in the subject's field of vision, wherein
the optical member includes a plurality of mirrors, each having an angle with respect to a reference plane of the optical member different from each other.

3. The virtual image display apparatus according to claim 1, wherein each angle of the mirrors with respect to the reference plane varies along a direction parallel to the reference plane.

4. The virtual image display apparatus according to claim 1, wherein an aspect ratio of the image displayed by the display and an aspect ratio of the virtual image displayed by the optical member are different from each other.

5. The virtual image display apparatus according to claim 1, wherein the reference plane of the optical member is a surface on which the mirrors are disposed side by side.

6. The virtual image display apparatus according to claim 1, wherein the reference plane is a flat surface.

7. The virtual image display apparatus according to claim 1, wherein each of the mirrors is a beam splitter, and the optical member reflects a light of the image displayed by the display toward eyes of the subject and transmits a light coming from outside toward the eyes of the subject.
